(19) United States
(12) Patent Application Publication
(10) Pub. No.: US 2007/0214175 A1
(43) Pub. Date: Sep. 13, 2007

(54) Synchronization of metadata in a distributed file system

(75) Inventor: Alexandru Mitaru, Beaverton, OR (US)

Correspondence Address: HICKMAN PALERMO TRUONG & BECKER, LLP, 2055 GATEWAY PLACE, SUITE 550, SAN JOSE, CA, 95110, US

(73) Assignee: Omneon Video Networks

(21) Appl. No.: 11/371,579

(22) Filed: Mar. 8, 2006

(51) Int. Cl. G06F 7/00

(52) U.S. Cl. 707/104.1

(57) ABSTRACT

Use and distribution of a token and associated journal entries in a system with multiple metadata servers. A metadata server receives a token from one of a plurality of remote metadata servers. Remote metadata servers perform data modification operations during control of the token. The metadata server performs original data modification operations during control of the token.

### TECHNICAL FIELD

Embodiments of the invention relate to file system management. More particularly, embodiments of the invention relate to techniques for use of a file management system having distributed metadata servers that may be used, for example, in a system that may support video editing, video archiving and/or video distribution.

### BACKGROUND

In general, a file system is a program (or set of programs) that provides a set of functions related to the storage and retrieval of data. The data may be stored, for example, on a non-volatile storage device (e.g., hard disk) or volatile storage device (e.g., random access memory). Typically, there is a set of data (e.g., file name, access permissions) associated with a file that is referred to as “file metadata.” The file metadata can be accessed during the process of accessing a file.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of a system that may utilize a file system with distributed metadata servers.

FIG. 2 is a block diagram of one embodiment of an electronic system.

FIG. 3 is a block diagram of one embodiment of multiple metadata servers interconnected to synchronize file operations.

FIG. 4 is a block diagram of one embodiment of multiple metadata servers interconnected to synchronize file operations in steady state operation.

FIG. 5 is a flow diagram of one embodiment of use of a token and journals.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

System Overview

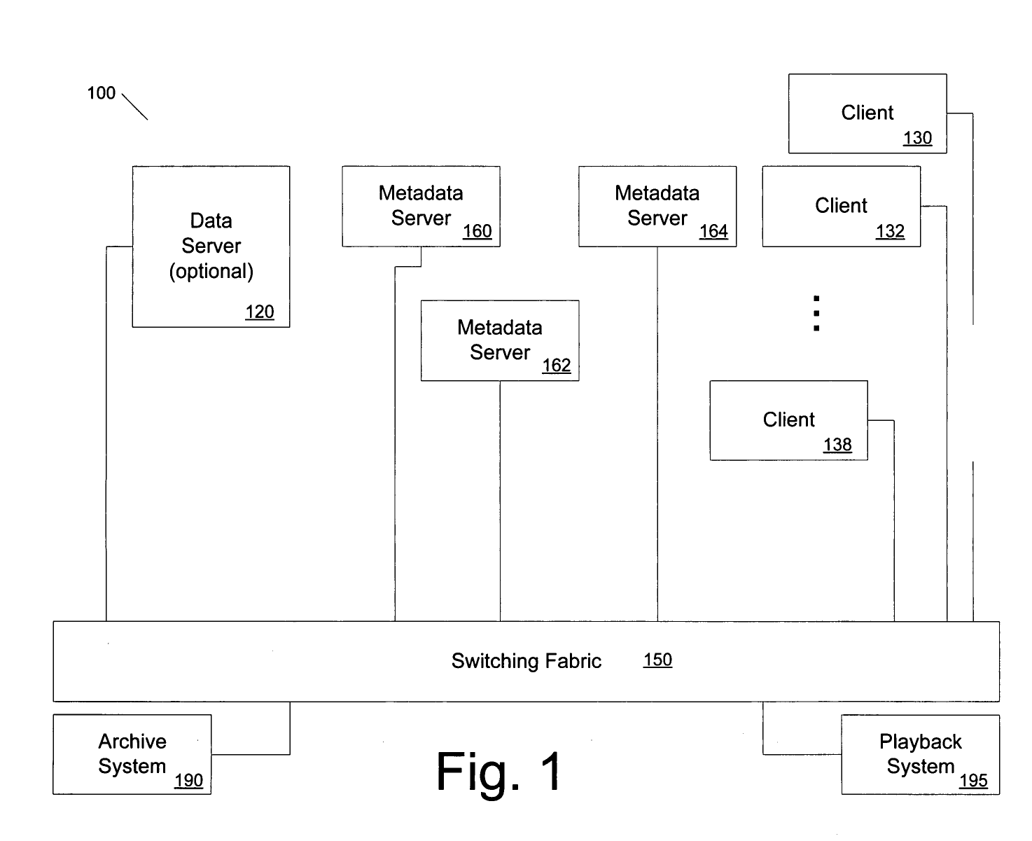

FIG. 1 is a block diagram of one embodiment of a system that may utilize a distributed file system with metadata servers. In one embodiment, the various components of the system of FIG. 1 are interconnected using standard interconnection technologies (e.g., Ethernet, Gigabit Ethernet). For example, in one embodiment, switching fabric 150 may be a Gigabit Ethernet (or 10 Gigabit Ethernet) interconnection architecture to allow the various components of system 100 to communicate with each other. Any interconnection protocol may be used.

In one embodiment, multiple client devices (e.g., 130, 132, . . . 138) may be interconnected via switching fabric 150. Client devices may allow users to access and/or otherwise utilize data available through system 100. In one embodiment, the client devices are computer systems having sufficient storage and input/output capability to allow users to manipulate data stored in various servers. For example, in a multimedia system, the client devices may allow users to access stored multimedia files as well as edit or otherwise utilize the multimedia files.

In one embodiment, the system of FIG. 1 may include any number of metadata servers, each of which may store metadata for files that are stored in the system. In one embodiment, a metadata server may be responsible for managing the file system and may be the primary point of contact for client devices. In one embodiment, each client device may include file system driver (FSD) software that may present a standard file system interface, for accessing files the system. System 100 may optionally include any number of data servers (e.g., 120) that may store data accessible by client devices and/or metadata servers.

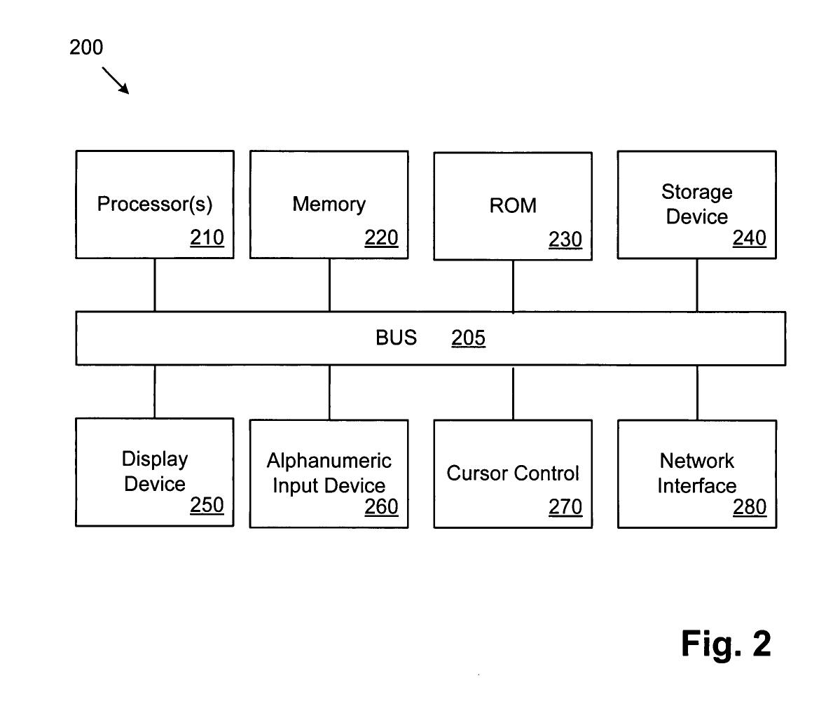

In one embodiment, the various electronic systems of FIG. 1 (e.g., data servers, metadata servers, clients) as an electronic system such as, for example, the electronic system of FIG. 2. The electronic system illustrated in FIG. 2 is intended to represent a range of electronic systems, for example, computer systems, network access devices, etc. Alternative systems, whether electronic or non-electronic, can include more, fewer and/or different components.

Electronic system 200 includes bus 201 or other communication device to communicate information, and processor 202 coupled to bus 201 to process information. While electronic system 200 is illustrated with a single processor, electronic system 200 can include multiple processors and/or co-processors. Electronic system 200 further includes random access memory (RAM) or other dynamic storage device 204 (referred to as memory), coupled to bus 201 to store information and instructions to be executed by processor 202. Memory 204 also can be used to store temporary variables or other intermediate information during execution of instructions by processor 202.

Electronic system 200 also includes read only memory (ROM) and/or other static storage device 206 coupled to bus 201 to store static information and instructions for processor 202. Data storage device 207 is coupled to bus 201 to store information and instructions. Data storage device 207 such as a magnetic disk or optical disc and corresponding drive can be coupled to electronic system 200.

Electronic system 200 can also be coupled via bus 201 to display device 221, such as a cathode ray tube (CRT) or liquid crystal display (LCD), to display information to a user. Alphanumeric input device 222, including alphanumeric and other keys, is typically coupled to bus 201 to communicate information and command selections to processor 202. Another type of user input device is cursor control 223, such as a mouse, a trackball, or cursor direction keys to communicate direction information and command selections to processor 202 and to control cursor movement on display 221. Electronic system 200 further includes network interface 230 to provide access to a network, such as a local area network.

Instructions are provided to memory from a storage device, such as magnetic disk, a read-only memory (ROM) integrated circuit, CD-ROM, DVD, via a remote connection (e.g., over a network via network interface 230) that is either wired or wireless providing access to one or more electronically-accessible media, etc. In alternative embodiments, hard-wired circuitry can be used in place of or in combination with software instructions. Thus, execution of sequences of instructions is not limited to any specific combination of hardware circuitry and software instructions.

An electronically-accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

Example Multiple Metadata Server Architecture

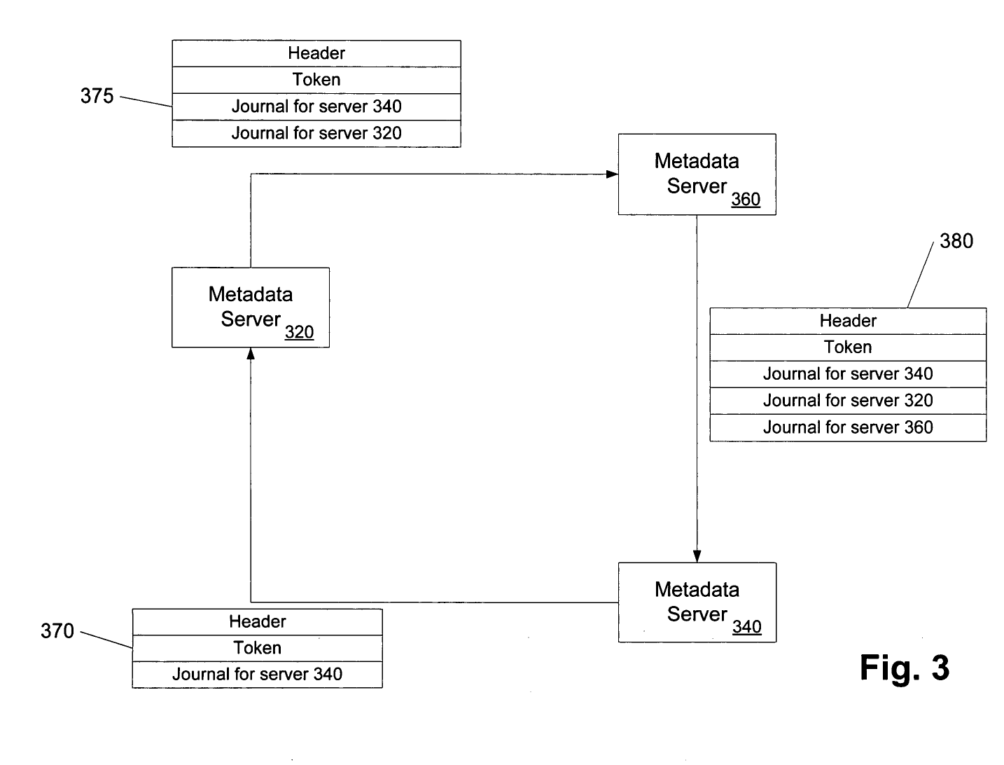

FIG. 3 is a block diagram of one embodiment of multiple metadata servers interconnected to synchronize file operations. As described in greater detail below, the mechanism illustrated in FIG. 3 may facilitate data synchronization and/or provide updates to data modification updates to multiple metadata servers. The example of FIG. 3 includes three metadata servers for reasons of simplicity of description only. Any number of metadata servers may be supported utilizing the mechanisms described herein.

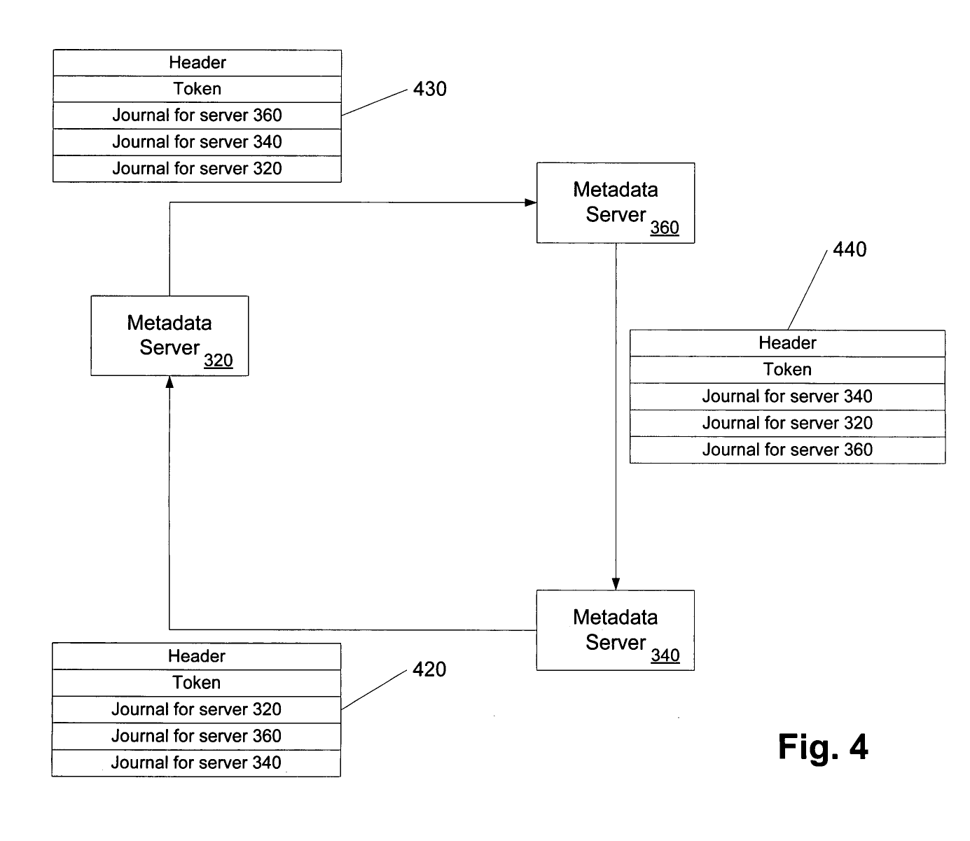

In general, a directional ring may be established between the metadata servers of a system such as, for example, the system of FIG. 1. The directional ring may be established in any manner known in the art. The example of FIG. 3 corresponds to a first cycle through the metadata servers. FIG. 4 provides an illustration of a steady state operation.

In one embodiment, the metadata servers share a token that is “owned” by only one of the multiple data servers at a particular time. Only the metadata server that currently owns the token is authorized to allow data modifications. In one embodiment, the token is passed between the multiple metadata servers according to the directional ring that has been established.

In one embodiment, the token may be transmitted between metadata servers in a data structure that also may include information defining the data modification operations performed by each metadata server. In one embodiment, metadata server 340 may be the first metadata server to own the token after initialization of the directional ring interconnection metadata servers 320, 340 and 360. During the initial ownership period one or more data modification operations may be performed. In one embodiment, metadata server 340 may maintain a listing of these data modification operations, which are the journal for metadata server 340.

At the conclusion of the token ownership period for metadata server 340, data structure 370 may be transmitted from metadata server 340 to metadata server 320. In one embodiment, data structure 370 may include a header that may include any type of information, for example, a source identifier, a destination identifier, a payload size, etc.

In response to receiving data structure 370, metadata server 320 may update a local data modification journal or other record of data modification operations performed by metadata server 340. Metadata server 320 may also perform any data modifications necessary to support data coherency with the data modification operations performed by metadata server 340. In one embodiment, after processing the journal for metadata server 340, metadata server 320 may perform or allow data modification operations during the period that it owns the token. In one embodiment, metadata server 320 may maintain a journal that may be transmitted at the end of the token ownership period.

At the conclusion of the token ownership period for metadata server 320, data structure 375 may be transmitted from metadata server 320 to metadata server 360. In one embodiment, data structure 375 may include a header that may include any type of information, for example, a source identifier, a destination identifier, a payload size, etc. Data structure 375 may further include the journal for metadata server 340 and the journal for metadata server 320.

In response to receiving data structure 375, metadata server 360 may update a local data modification journal or other record of data modification operations performed by metadata server 340 and then operations performed by metadata server 320. Metadata server 360 may also perform any data modifications necessary to support data coherency with the data modification operations performed by metadata server 340 and then the data modification operations performed by metadata server 320. In one embodiment, after processing the journal for metadata servers 340 and 320, metadata server 360 may perform or allow data modification operations during the period that it owns the token. In one embodiment, metadata server 360 may maintain a journal that may be transmitted at the end of the token ownership period.

At the conclusion of the token ownership period for metadata server 360, data structure 380 may be transmitted from metadata server 360 to metadata server 340. In one embodiment, data structure 380 may include a header that may include any type of information, for example, a source identifier, a destination identifier, a payload size, etc. Data structure 380 may further include the journal for metadata server 340, the journal for metadata server 320 and the journal for metadata server 360.

Token And Journals

FIG. 4 is a block diagram of one embodiment of multiple metadata servers interconnected to synchronize file operations in steady state operation. In general, the data structure transmitted between metadata servers may include a header, the token or an indication of ownership of the token, and an journal for each metadata server in an order corresponding to the configuration of the directional ring.

At the conclusion of the token ownership period for metadata server 340, data structure 420 may be transmitted from metadata server 340 to metadata server 320. In one embodiment, data structure 420 may include a header that may include any type of information, for example, a source identifier, a destination identifier, a payload size, etc. Data structure 420 may further include the journal for metadata server 340, the journal for metadata server 320 and the journal for metadata server 360

Similarly, at the conclusion of the token ownership period for metadata server 320, data structure 430 may be transmitted from metadata server 320 to metadata server 360. In one embodiment, data structure 430 may include a header that may include any type of information, for example, a source identifier, a destination identifier, a payload size, etc. Data structure 430 may further include the journal for metadata server 360, the journal for metadata server 340 and the journal for metadata server 320.

At the conclusion of the token ownership period for metadata server 360, data structure 440 may be transmitted from metadata server 360 to metadata server 340. In one embodiment, data structure 440 may include a header that may include any type of information, for example, a source identifier, a destination identifier, a payload size, etc. Data structure 440 may further include the journal for metadata server 340, the journal for metadata server 320 and the journal for metadata server 360.

In one embodiment, the process illustrated in FIG. 4 may continue until the host system is reset. That is, the circulating of the token and journals may be used continuously to provide data coherency as well as to update metadata server status information. The conceptual data structures of FIGS. 3 and 4 are for purposes of illustration only. Any technique to transmit the type of data described may also be used.

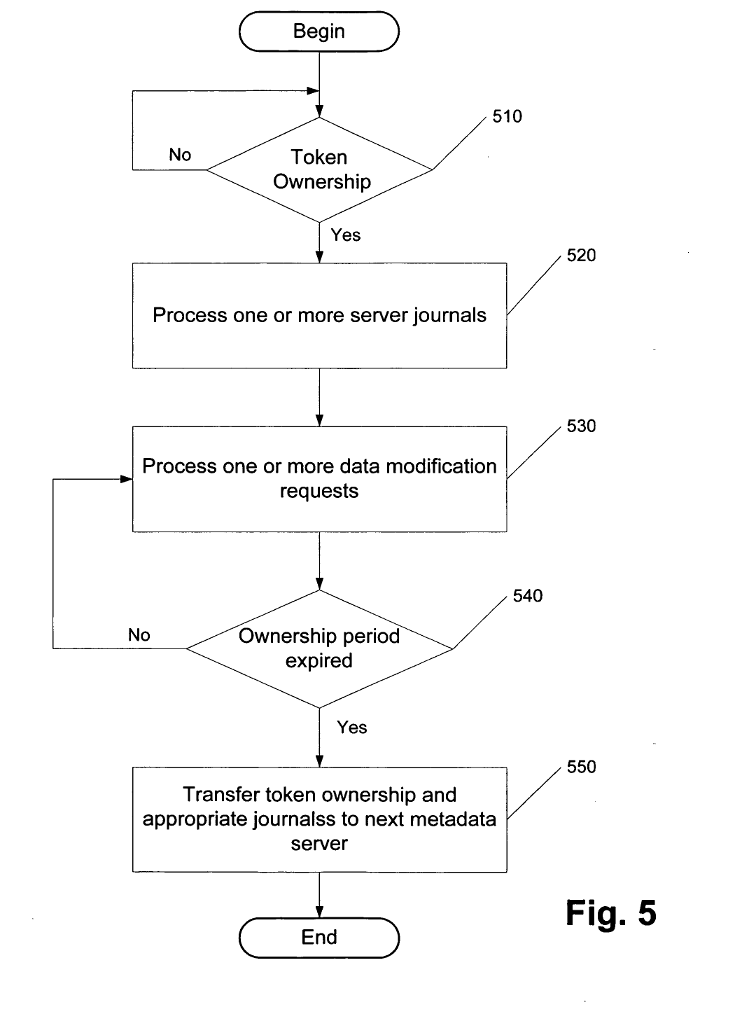

FIG. 5 is a flow diagram of one embodiment of use of a token and journals. A metadata server coupled as illustrated in FIGS. 3-4 may perform the process of FIG. 5, for example. Other interconnection configurations may also be supported.

A metadata server may determine whether is owns the token, 510. Any technique known in the art may be utilized to determine and/or transfer token ownership. In one embodiment, when a metadata server does not own the token, that metadata server may not authorize data modification operations (e.g., write, delete). In one embodiment, when a metadata server does not own the token, operations that would modify the file system metadata are delayed until it receives and owns the token.

If the metadata server does own the token, 510, the metadata server may process one or more journals corresponding to other metadata servers coupled in a directional ring, 520. As described above, processing of the journals may be performed in an order corresponding to an order in which the token is passed through multiple metadata servers coupled in a directional ring. In one embodiment, the portion of the data structure that carries the journals may be considered a circular buffer with “n” journals where “n” is the number of metadata servers in the system.

After processing the journals, 520, the metadata server may process one or more data modification operations from client devices, 530. In one embodiment, part of the processing of data modification operations from client devices is maintaining a listing of operations in order to generate the journal for the metadata server. The metadata server may continue processing data modification operations until the token ownership period has expired, 540.

In one embodiment, in response to expiration of the token ownership period, 550, the metadata server transfer token ownership to the next metadata server in the directional ring. In one embodiment, the transfer of the token ownership may include transfer of one or more journals corresponding to other metadata servers as well as the newly generated journal.

### CONCLUSION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A system comprising:
an interconnection mechanism to carry data between a source and a destination;
a plurality of metadata servers logically interconnected via the interconnection mechanism, the plurality of metadata servers to receive and transmit a token, wherein only one of the metadata servers controls the token at a time and further wherein the token is associated with one or more journals having data corresponding to file modification operations.

2. The system of claim 1 wherein the plurality of metadata servers are logically interconnected as a directional ring.

3. The system of claim 1 wherein the interconnection mechanism comprises an interconnection fabric compliant with a Gigabit Ethernet standard.

4. The system of claim 3 wherein the Gigabit Ethernet standard comprises a 10 Gigabit Ethernet standard.

5. The system of claim 1 wherein each metadata server of the plurality of metadata servers performs data modifications corresponding to other metadata servers as indicated by the journals during control of the token.

6. The system of claim 5 wherein each metadata server generates a journal having entries corresponding to data modification operations performed during control of the token and transmits the journal in response to expiration of control of the token.

7. A method comprising:
receiving, with a metadata server, a token from one of a plurality of remote metadata servers;
synchronizing data modification operations performed by remote metadata servers during control of the token; and
performing original data modification operations during control of the token.

8. The method of claim 7 further comprising passing the token to a remote metadata server in response to expiration of control of the token.

9. The method of claim 7 further comprising generating a journal having entries corresponding to the original data modification operations performed by the metadata server during control of the token.

10. The method of claim 9 wherein the journal is transmitted to a remote metadata server in response to expiration of control of the token.

11. The method of claim 7 wherein the metadata server and the plurality of remote metadata servers are logically interconnected as a directional ring.

12. The method of claim 7 wherein synchronization of data modification operations performed by remote metadata servers comprises performing data modifications operations previously performed by the remote metadata servers.

13. The method of claim 12 wherein, for each remote metadata server, a journal having one or more entries corresponding to data modifications operations previously performed by the remote metadata servers is received in association with the token.

14. An article comprising a computer-readable medium having stored thereon sequences of instructions that, when executed, cause one or more processors to:
receive, with a metadata server, a token from one of a plurality of remote metadata servers;
synchronize data modification operations performed by remote metadata servers during control of the token; and
perform local data modification operations during ownership of the token.

15. The article of claim 14 further comprising instructions that, when executed, cause the one or more processors to pass the token to a remote metadata server in response to expiration of ownership of the token.

16. The article of claim 14 further comprising instructions that, when executed, cause the one or more processors to generate a journal having entries corresponding to the original data modification operations performed by the metadata server during ownership of the token.

17. The article of claim 16 wherein the journal is transmitted to a remote metadata server in response to expiration of ownership of the token.

18. The article of claim 14 wherein the metadata server and the plurality of remote metadata servers are logically interconnected as a directional ring.

19. The article of claim 14 wherein synchronization of data modification operations performed by remote metadata servers comprises performing data modifications operations previously performed by the remote metadata servers.

20. The article of claim 19 wherein, for each remote metadata server, a journal having one or more entries corresponding to data modifications operations previously performed by the remote metadata servers is received in association with the token.

21. An apparatus comprising:
means for receiving, with a metadata server, a token from one of a plurality of remote metadata servers;
means for synchronizing data modification operations performed by remote metadata servers during control of the token; and
means for performing original data modification operations during control of the token.

22. The apparatus of claim 21 further comprising means for passing the token to a remote metadata server in response to expiration of control of the token.

23. The apparatus of claim 21 further comprising means for generating a journal having entries corresponding to the local data modification operations performed by the metadata server during ownership of the token.
